(19) United States
(12) Patent Application Publication
(10) Pub. No.: US 2008/0115665 A1
(43) Pub. Date: May 22, 2008

(54) Apparatus for dehydrator and compressor combination skid and method of operation

(75) Inventors: Swen Theil, Airdrie (CA); Rick Bower, Calgary (CA)

Correspondence Address: LERNER, DAVID, LITTENBERG,;KRUMHOLZ & MENTLIK, 600 SOUTH AVENUE WEST, WESTFIELD, NJ, 07090, US

(73) Assignees: Leader Energy Services Ltd., Calgary (CA); Bower Damberger Rolseth Engineering Ltd., Calgary (CA)

(21) Appl. No.: 11/891,653

(22) Filed: Aug. 10, 2007

Related U.S. Application Data
(63) Continuation-in-part of application No. 11/604,017, filed on Nov. 22, 2006.

(30) Foreign Application Priority Data
Aug. 11, 2006 (CA) 2,555,905

(51) Int. Cl. B01D 19/00

(52) U.S. Cl. 95/18; 96/218; 96/173; 95/161

(57) ABSTRACT

A method and apparatus for the dehydration of glycol, comprising a gas compressor unit including an engine which produces a flow of hot exhaust gas; a glycol dehydrator unit including a reboiler for heating and dehydrating the glycol; transferring heat from the exhaust gas to the reboiler to heat the glycol; and a support platform, wherein the gas compressor unit, the glycol dehydrator unit and the circuit for transferring heat are all supported on the support platform.

### CROSS-REFERENCE TO RELATED APPLICATIONS

This application is a continuation-in-part of U.S. application Ser. No. 11/604,017, filed on Nov. 22, 2006, the disclosure of which is incorporated herein by reference.

### FIELD OF THE INVENTION

The present invention relates generally to heat transfer systems and more specifically to the transfer of heat generated by a compressor motor for use in a dehydrator to remove water dissolved in a carrier fluid such as glycol.

### BACKGROUND OF THE INVENTION

Gas compressors are commonly used to pressurize natural gas in order to facilitate the gas's movement through pipelines and other facilities.

Glycol dehydration is a process that removes naturally occurring water, usually in the form of vapour, from natural gas, thereby preventing hydrate formation in and corrosion of gas pipelines. A glycol dehydration unit exposes natural gas to glycol. When natural gas comes in contact with glycol, the glycol removes water vapour from the natural gas. However, the glycol itself eventually becomes saturated with water and ineffective at removing water vapour from natural gas. At this point, the glycol and water mixture is moved to a glycol reboiler forming part of a glycol dehydration unit. The glycol reboiler separates the water from the glycol by raising the temperature of the mixture to a level that will cause the water to evaporate but is below the boiling point of glycol. After the water has been evaporated, the glycol may again be used to remove water vapour from natural gas.

Conventional glycol dehydration units are gas-fired to generate the necessary heat to flash off the water dissolved in the glycol. There are several drawbacks associated with these units: safety issues; the cost of the fuel they consume; the negative environmental impact caused by their burning of fuel. With respect to safety issues, a conventional glycol dehydration unit cannot even be placed on the same skid as a gas compressor unit because of the explosion hazards. This greatly increases the cost of manufacturing and installation and makes it expensive to transport or move the units from place to place.

### SUMMARY OF THE INVENTION

The present invention is directed toward a combination gas compressor unit and a glycol dehydrator unit wherein exhaust heat from the compressor's prime mover is transferred and used in the glycol dehydrator unit. One objective of the present invention is to provide an easy to manufacture and mobile apparatus that combines a gas compressor and a glycol dehydrator on one skid. Another objective of the present invention is to provide an apparatus that transfers the heat generated by a gas compressor unit to the glycol reboiler of the glycol dehydrator. Another objective of the present invention is to provide a glycol reboiler that does not burn fuel to achieve its requisite temperature. Yet another objective of the present invention is to provide a glycol dehydrator that is safer than fuel-fired dehydrators.

The stated objectives are accomplished by a novel apparatus wherein a gas compressor and a glycol dehydrator are manufactured together on a single skid. A closed fluid circuit connects a heat exchanger in the exhaust of the compressor unit with a heat exchanger in the glycol reboiler of the glycol dehydrator. A heat transfer fluid is pumped through the closed circuit. Heat is transferred to the heat transfer fluid as it passes through the heat exchanger in the exhaust of the compressor's prime mover. As the heat transfer fluid flows through the heat exchanger in the reboiler, heat is transferred to the glycol and water mixture in the glycol reboiler to boil off the water content. The flow and/or temperature of the heat transfer fluid is regulated to maintain the requisite temperature in the glycol reboiler.

According to the present invention then there is provided an apparatus for the dehydration of glycol, comprising a gas compressor unit including an engine which produces a flow of hot exhaust gas; a glycol dehydrator unit including a reboiler for heating and dehydrating the glycol; means for transferring heat from said exhaust gas to said reboiler for heating the glycol; and a support platform, wherein said gas compressor unit, said glycol dehydrator unit and said means for transferring heat are all supported on said support platform.

According to another aspect of the present invention, there is also provided a method for the dehydration of glycol, comprising the steps of operating a gas compressor unit having an engine to produce a flow of hot exhaust gas; operating a glycol dehydrator unit having a reboiler to heat and thereby dehydrate the glycol; transferring heat from said hot exhaust gas to said reboiler through a heat transfer circuit to heat the glycol; and supporting said gas compressor unit, said glycol dehydrator unit and said heat transfer circuit on a single supporting platform.

### BRIEF DESCRIPTION OF THE DRAWINGS

Preferred embodiments of the present invention will now be described in greater detail and will be better understood when read in conjunction with the following drawings in which:

FIG. 1 is a schematical flow diagram of the of the combined compressor unit and dehydrator unit apparatus according to an embodiment of the invention;

FIG. 2 is a diagrammatic view of the exhaust gas heat exchanger forming part of the apparatus of FIG. 1; and

FIG. 3 is a schematical flow diagram of a modified apparatus in accordance with another aspect of the present invention.

### DETAILED DESCRIPTION

The construction and operation of both gas compressors and glycol dehydration units is well known in the art and a detailed description of how they function and are used is therefore omitted from the present description. There are many commercially available units in the market today and the skilled technician will be familiar with the selection of units having a size, capacity and throughput appropriate to any particular installation. The present invention is intended to be adapted for use in most if not all such installations either as original equipment, as a retrofit or as a temporary replacement.

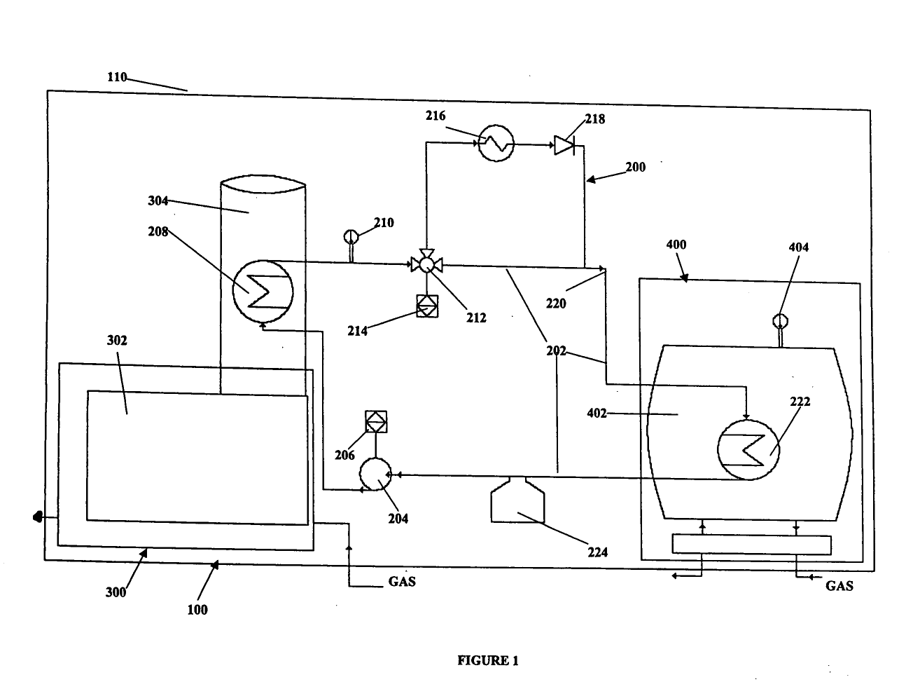

Referring to FIG. 1, the combined dehydration and compressor skid 100 of the present invention generally comprises a mounting skid 110, a closed loop fluid circuit 200 for a heat transfer fluid (also called “hot oil”), a gas compressor unit 300, and a glycol dehydrator unit 400. Compressor unit 300, glycol dehydrator 400 and fluid circuit 200 are mounted onto skid 110 which can be a transportable or permanently installed platform for these major components of the system.

Fluid circuit 200 comprises piping or tubing 202, a circulation pump 204, a pump controller 206, a first heat exchanger 208 in the exhaust stream from the compressor's prime mover 302, a first temperature gauge 210, a three way-valve 212, a three way valve controller 214, a third heat exchanger 216, a one way check valve 218, a three way connector 220, a second heat exchanger 222 disposed within the glycol reboiler 402 of glycol dehydrator 400 and a heat transfer fluid reservoir 224.

To complete closed loop fluid circuit 200, tubing 202 connects pump 204 to first heat exchanger 208; first heat exchanger to three way valve 212; three way valve 212 to third heat exchanger 216 and to three way connector 220; third heat exchanger 216 to three way connector 220; three way connector to second heat exchanger 222, second heat exchanger 222 to heat transfer fluid reservoir 224 and heat transfer fluid reservoir 224 back to pump 204 to close the loop. Third heat exchanger 216 is in contact with ambient air for shedding excess heat in the transfer fluid to atmosphere. First temperature gauge 210 is disposed in fluid piping 202 between first heat exchanger 208 and three way valve 212 to monitor the temperature of the transfer fluid leaving first heat exchanger. The check valve 218, disposed in fluid piping 202 between third heat exchanger 216 and three way connector 220, permits one-way flow only of heat transfer fluid from third heat exchanger 216 to three way connector 220.

Gas compressor 300 includes prime mover 302 and an exhaust manifold 304 that will typically also include a muffler for noise abatement. Prime mover 302 is a commercially available internal combustion engine or gas turbine manufactured by companies such as Caterpillar Corporation that can generate a thousand or more horsepower and produce exhaust stack temperatures that can exceed 400° C. First heat exchanger 208 is disposed in manifold 304 so that exhaust gas produced by compressor motor 302 heats the transfer fluid being pumped through first heat exchanger 208.

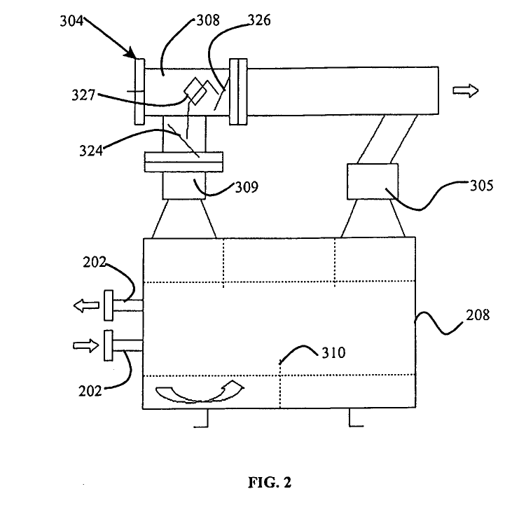

Reference is made to FIG. 2, wherein like numerals have been used to identify like elements, which illustrates an exemplary arrangement of heat exchanger 208 relative to manifold 304. Exhaust gas from motor 302 flows into a duct 308 and through a diverter 309 into heat exchanger 208. Inside the exchanger are a series of baffles 310 to cause the gas to circulate inside the exchanger and around the coils or loops (not shown) of tubing 202 for the heat transfer fluid. The cooled exhaust exits exchanger 208 through outlet 305 and back into duct 308 for eventual discharge to the atmosphere. Diverter 309 preferably includes a diverter valve 320 which is operable to direct the flow of gas into the heat exchanger by simultaneously closing duct 308 and opening the diverter, or closing the diverter and opening the duct by means of movable dampers 324 and 326. Valve 320 can also be partially opened to split the flow of exhaust gas for additional control over the temperature of the transfer fluid flowing through exchanger 208. Valve 320 can be manually operated but more preferably its operation is automated using an actuator 327 drivingly connected to valve 320 and dampers 324 and 326 that is responsive to the temperature of the heat transfer fluid monitored by fluid temperature gauge 210. The actuator 327 will route the exhaust flow as needed through heat exchanger 208 to maintain the temperature of the heat transfer fluid at a predetermined temperature. This temperature will be approximately 290° C. This temperature is however exemplary and it may be different or varied as required depending on operating conditions. If temperature gauge 210 detects a temperature lower than 290° C., actuator 327 will route more exhaust gas through exchanger 208, and conversely, if the temperature of the heat transfer fluid exceeds the preset value, actuator 327 will adjust valve 320 as needed to direct less exhaust gas through exchanger 208.

As mentioned above, glycol dehydrator 400 includes a glycol reboiler 402. Glycol reboiler 402 includes its own temperature gauge 404 to monitor the temperature of the glycol being heated inside the reboiler by second heat exchanger 222. As is known in the art, glycol dehydrator unit 400 circulates hydrated glycol to glycol reboiler 402 where the water is boiled off and the escaping vapour is exhausted to the atmosphere.

A description of the operation of compressor skid 100 according to an embodiment of the present invention follows.

Fluid circuit 200 is filled with a heat transfer fluid such as Dowtherm™ RP or Q or Sun™ 21. These products are rated for heating to at least 290° to 300° C. Pump 204 circulates the heat transfer fluid around fluid circuit 200 at a predetermined rate which will be controlled by pump controller 206. Controller 206 can be manually or automatically controlled as known in the art for fine tuning the rate at which the heat transfer fluid is pumped. In one embodiment constructed by the applicant, the predetermined rate is 9.7 gallons per minute or approximately 2125 kg per hour. This rate is exemplary only and other rates are contemplated as required or depending upon system capacity, operating conditions and the like. The heat transfer fluid flows initially from pump 204, through piping 202 to first heat exchanger 208 where its heated by exhaust gas from manifold 304 as described below. Next, the heat transfer fluid flows to three way valve 212. Three way valve 212 is operable to permit heat transfer fluid to flow either to third heat exchanger 216 or to second heat exchanger 222 or both. Heat transfer fluid directed by three way valve 212 to third heat exchanger 216 is cooled by ambient air as it passes through the exchanger and then flows through check-valve 218 and on to second heat exchanger 222. The heat transfer fluid flowing through second heat exchanger 222 heats the glycol in glycol reboiler 402 to a predetermined temperature. This preset temperature will be approximately 190° C., but as will be apparent to those skilled in the art, the temperature can be higher or lower as desired or required. From second heat exchanger 222, the heat transfer fluid then flows to heat transfer fluid reservoir 224 and back to pump 204, completing fluid circuit 200.

First temperature gauge 210 monitors the temperature of heat transfer fluid after it has passed through first heat exchanger 208. Second temperature gauge 404 monitors the temperature of glycol in the glycol reboiler 402.

As mentioned above, the present system maintains the temperature of the glycol in reboiler 402 in the approximate range of 190° C. which is greater than the boiling point of water but less than the boiling point of glycol. In the embodiment of FIG. 1, the temperature in glycol reboiler 402 is regulated by up to three mechanisms. First, pump controller 206 controls the rate of flow of heat transfer fluid through fluid circuit 200 by adjusting the speed of pump 204. Second, the three way valve controller 214 operates three way valve 212 to direct the heat transfer fluid either directly to second heat exchanger 222 in whole or in part or to third heat exchanger 216, where the heat transfer fluid will be cooled prior to its arrival at second heat exchanger 222. Third, the amount of exhaust gas flowing through first exchanger 208 can be regulated by diverter valve 320.

The temperature at first temperature gauge 210 and second temperature gauge 404 is analyzed to determine if the heat transfer fluid is too hot or too cold to maintain the preset temperature of the glycol in reboiler 402. If the heat transfer fluid is too hot or too cold, one or more of the three temperature regulation mechanisms described above is used to adjust the temperature and/or flow rate of the heat transfer fluid appropriately. This process can of course be automated using conventional thermostatic controls or a computerized system as will be known in the art.

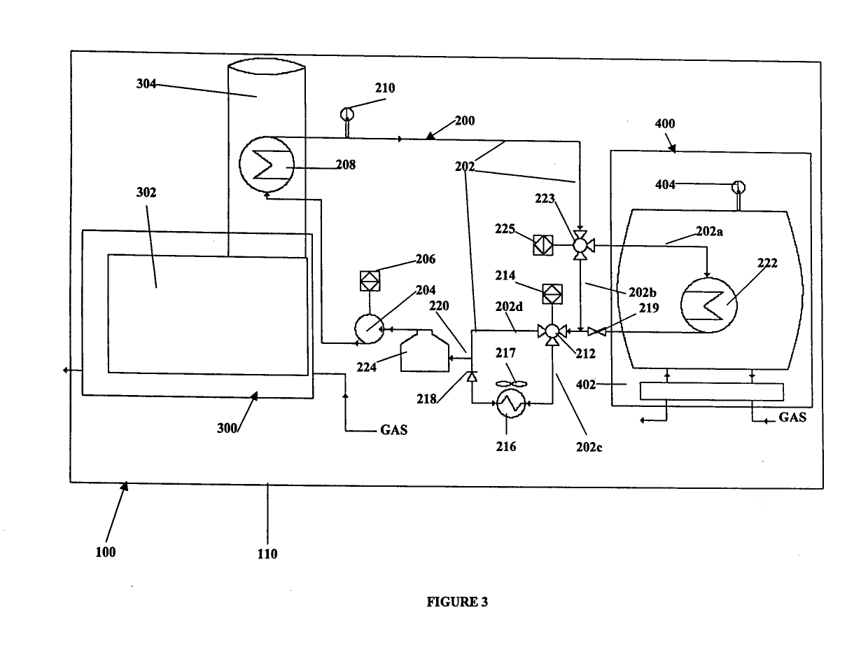

Reference is now made to FIG. 3 showing another embodiment of a combined dehydrator and compressor skid 100 in which like numerals have been used to identify like elements. As in the embodiment of FIG. 1, the system includes a closed loop fluid circuit 200 for the heat transfer fluid, gas compressor unit 300 and a glycol dehydrator unit 400, all of which are supported by skid or platform 110. The primary difference between this system and that shown in FIG. 1 includes an additional three way valve 223 and associated controller 225 that can be used to control the flow of hot oil through second heat exchanger 222, and the placement of heat exchanger 216, including a fan 217 as required, between heat exchanger 222 and fluid reservoir 224 instead of between heat exchanger 208 and heat exchanger 222.

As in the embodiment of FIG. 1, tubing 202 connects pump 204 to first exchanger 208. But then tubing 202 connects first heat exchanger 208 to three way valve 223. Three way valve 223 is connected by tubing 202a to second heat exchanger 222 and by tubing 202b to three way valve 212 via three way connector 220. Three way valve 212 is connected by tubing 202c to third heat exchanger 216 and by tubing 202d to reservoir 224 via another three way connector 220. Check valves 218 and 219 are included in the tubing to prevent reverse flow of heat transfer fluid through heat exchangers 216 and 222 respectively. Additional tubing 202 connects reservoir 224 back to pump 204 to complete the loop.

In the embodiment of FIG. 3, the temperature in glycol reboiler 402 is controlled primarily by the amount of hot oil routed through heat exchanger 222 which in turn is controlled by controller 225 that opens and closes three way valve 223 in response to the temperature of the glycol in the reboiler as monitored by temperature sensor 404. Assuming a predetermined or preset glycol temperature of 190° C., if sensor 404 detects a lower temperature, controller 225 is actuated to deviate additional hot oil through heat exchanger 222. If sensor 404 detects a higher glycol temperature, more of the hot oil will be routed through tubing 202b to bypass heat exchanger 216 or back to reservoir 224 or both.

Third heat exchanger 216 is actually optional. As mentioned above, it can be used to exhaust excess heat to the atmosphere. But it is also possible to make use of any excess heat not required by the glycol reboiler. For example, the heat available from third exchanger 216 can be used to boil water by means of an evaporator, to transfer the heat to air that can be used to heat buildings or rooms within buildings or even to create steam that can run a turbine to generate electricity. As will be appreciated by those skilled in the art, other uses of excess waste heat can be found. Actuator 214 is programmed to operate valve 16 to direct heat transfer fluid to third exchanger 216 only if there is a threshold amount of heat remaining in the heat transfer fluid after flowing through or past the glycol reboiler.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus for the dehydration of glycol, comprising:
a gas compressor unit including an engine which produces a flow of hot exhaust gas;
a glycol dehydrator unit including a reboiler for heating and dehydrating the glycol;
means for transferring heat from said exhaust gas to said reboiler for heating the glycol; and
a support platform, wherein said gas compressor unit, said glycol dehydrator unit and said means for transferring heat are all supported on said support platform.

2. The apparatus of claim 1 wherein said means for transferring heat comprise a closed fluid circuit, said circuit including:
a supply of heat transfer fluid substantially filling said circuit;
a first heat exchanger disposed in said flow of hot exhaust gas for heating said heat transfer fluid circulated through said first heat exchanger;
a second heat exchanger in said reboiler for receiving said heat transfer fluid from said first heat exchanger for transferring heat to the glycol; and
pump means, wherein said pump means controllably circulate said heat transfer fluid through said closed fluid circuit.

3. The apparatus of claim 2 including means for controlling the temperature of said heat transfer fluid received into said second heat exchanger.

4. The apparatus of claim 3 wherein said means for controlling the temperature of said heat transfer fluid comprise:
a temperature gauge for measuring the temperature of said heat transfer fluid leaving said first heat exchanger;
valve means for adjustably controlling the volume of hot exhaust gas flowing through said first heat exchanger; and
actuator means operably connected to said valve means to open and close the same in response to signals from said temperature gauge to respectively permit more or less exhaust gas to flow through said first exchanger to maintain said heat transfer fluid at a predetermined temperature.

5. The apparatus of claim 4 wherein said means for controlling the temperature of said heat transfer fluid additionally comprise:
a parallel fluid circuit in fluid communication with said closed fluid circuit between said first heat exchanger and said second heat exchanger, said parallel fluid circuit comprising a third heat exchanger arranged to remove heat from said heat transfer fluid;
a three way valve operable in response to signals from said temperature gauge to adjustably direct flow or to block flow of said heat transfer fluid through said parallel circuit; and
a three way valve control means for operating said three way valve in response to said signals from said temperature gauge.

6. The apparatus of claim 4 wherein said means for controlling the temperature of said heat transfer fluid additionally comprise:
a pump controller;
wherein said pump controller controls the rate at which said pump means circulate said heat transfer fluid through said closed fluid circuit.

7. The apparatus of claim 6 further comprising means for controlling the temperature of the glycol in said reboiler.

8. The apparatus of claim 7 wherein said means for controlling the temperature of the glycol in said reboiler comprises:
a temperature sensor for sensing the temperature of the glycol in said reboiler and to produce signals responsive to said temperature;
three way valve means being operable for adjustably controlling the amount of heat transfer fluid flowing through said second heat exchanger;
actuator means operatively connected to said three way valve means to open and close the same in response to said signals from said temperature sensor to respectively permit more or less of said heat transfer fluid to flow through said second heat exchanger as required to maintain the glycol in said reboiler at a predetermined temperature.

9. The apparatus of claim 8 wherein said means for controlling the temperature of the glycol in said reboiler additionally comprise:
a parallel bypass fluid circuit with a first connection to said closed fluid circuit before said second heat exchanger and a second connection to said closed fluid circuit after said second heat exchanger;
said three way valve means being operable by said actuator means to block flow or to direct flow of said heat transfer fluid through said bypass fluid circuit depending upon the amount of said heat transfer fluid required to maintain said glycol at said predetermined temperature in said reboiler.

10. The apparatus of claim 9 wherein said closed fluid circuit comprises a check valve for preventing reverse flow of said heat transfer fluid through said second heat exchanger.

11. The apparatus of claim 9 further comprising:
a second parallel fluid circuit that connects to said closed fluid circuit after said second connection of said bypass fluid circuit, said second parallel fluid circuit incorporating a third heat exchanger;
a second three way valve means operable to block flow or to direct flow of said heat transfer fluid through said second parallel fluid circuit;
a second three way valve control means;
wherein said second three way valve control means operate said second three way valve to adjustably control the flow of said heat transfer flow through said third heat exchanger.

12. The apparatus of claim 11 wherein said second parallel fluid circuit comprises a check valve for preventing reverse flow of said heat transfer fluid through said third heat exchanger.

13. The apparatus of claim 11 wherein said third heat exchanger is exposed to ambient air for removing excess heat from said heat transfer fluid.

14. The apparatus of claim 13 wherein said third heat exchanger includes a fan to facilitate removing heat from said heat transfer fluid.

15. The apparatus of claim 11 wherein said third heat exchanger transfers heat to at least one of a water boiling system, a space heating system, or a steam creating system for running an electricity generating turbine.

16. A method for the dehydration of glycol, comprising the steps of:
operating a gas compressor unit having an engine to produce a flow of hot exhaust gas;
operating a glycol dehydrator unit having a reboiler to heat and thereby dehydrate the glycol;
transferring heat from said hot exhaust gas to said reboiler through a heat transfer circuit to heat the glycol; and
supporting said gas compressor unit, said glycol dehydrator unit and said heat transfer circuit on a single supporting platform.

17. The method of claim 16 wherein transferring heat from said hot exhaust gas to said reboiler comprises the steps of:
filling said heat transfer circuit with a heat transfer fluid;
placing a first heat exchanger forming part of said heat transfer circuit in said flow of hot exhaust gas to transfer heat from exhaust gas to said heat transfer fluid;
placing a second heat exchanger forming part of said heat transfer circuit in said reboiler;
circulating hot heat transfer fluid from said first heat exchanger to said second heat exchanger for heating the glycol; and
pumping said heat transfer fluid through said heat transfer circuit at a controlled rate.

18. The method of claim 17 including the additional step of controlling the temperature of said heat transfer fluid circulated to said second heat exchanger.

19. The method of claim 18 wherein the step of controlling the temperature of said heat transfer fluid comprises:
monitoring the temperature of said heat transfer fluid leaving said first heat exchanger;
responsive to said monitored temperature, making adjustments to the amount of hot exhaust gas flowing through said first heat exchanger; and
maintaining the heat transfer fluid at a predetermined temperature by means of said adjustments to the amount of hot exhaust gas flowing through said first heat exchanger.

20. The method of claim 19 including the additional step of controlling the temperature of the glycol in said reboiler.

21. The method of claim 20 wherein the step of controlling the temperature of the glycol comprises:
sensing the temperature of the glycol in the reboiler;
responsive to said sensed temperature, making adjustments as required to the amount of heat transfer fluid flowing through said second heat exchanger; and
maintaining the glycol at a predetermined temperature by means of said adjustments to the amount of heat transfer fluid flowing through said second heat exchanger.

22. The method of claim 19 including the additional step of maintaining the glycol in said reboiler at a predetermined temperature.

23. The method of claim 22 wherein said step of maintaining the glycol at a predetermined temperature comprises:
monitoring the temperature of said heat transfer fluid after it leaves said first heat exchanger and before it enters said second heat exchanger;
monitoring the temperature of the glycol in said reboiler;
analysing said monitored temperature of said heat transfer fluid and said monitored temperature of the glycol to make a determination if the flow of said heat transfer fluid to said second heat exchanger should be increased or decreased to maintain said predetermined temperature; and
increasing or reducing the flow of said heat transfer fluid to said second heat exchanger according to said determination using flow adjustment means.

24. The method of claim 23 wherein said flow adjustment means increase the flow of said heat transfer fluid through a fluid bypass circuit forming part of said heat transfer circuit in response to a decrease in the flow of said heat transfer fluid to said second heat exchanger, and decrease the flow of said heat transfer fluid through said fluid bypass circuit in response to an increase in the flow of said heat transfer fluid to said second heat exchanger.

25. The method of claim 24 comprising the additional step of monitoring the temperature of said heat transfer fluid after it flows through or bypasses said second heat exchanger and directing said flow of said heat transfer fluid to a third heat exchanger if said heat transfer fluid exceeds a predetermined threshold temperature after flowing through or bypassing said second heat exchanger.

26. The method of claim 25 wherein said glycol is heated to a temperature between the boiling point of water and the boiling point of the glycol.

27. The apparatus of claim 4 wherein said predetermined temperature of said heat transfer fluid is about 290° C.

28. The apparatus of claim 8 wherein said predetermined temperature of said glycol is about 190° C.

29. The method of claim 21 wherein said predetermined temperature of said heat transfer fluid is about 290° C.

30. The method of claim 22 wherein said predetermined temperature of said glycol is 190° C.
